(19) United States
(12) Patent Application Publication
(10) Pub. No.: US 2017/0094148 A1
(43) Pub. Date: Mar. 30, 2017

(54) IMAGING APPARATUS WITH A FLICKER DETECTION FUNCTION

(71) Applicant: CASIO COMPUTER CO., LTD., Tokyo (JP)

(72) Inventor: Takeshi TSUKAGOSHI, Tokyo (JP)

(73) Assignee: CASIO COMPUTER CO., LTD., Tokyo (JP)

(21) Appl. No.: 15/195,589

(22) Filed: Jun. 28, 2016

(30) Foreign Application Priority Data
Sep. 24, 2015 (JP) 2015-186479

(51) Int. Cl. H04N 5/235

(52) U.S. Cl. CPC H04N 5/2357; H04N 5/2353

(57) ABSTRACT

An external light source with a blinking period serving as a flicker occurrence factor can be reliably and quickly detected under any imaging environment from among a plurality of different external light sources with blinking periods. When a frame period where the phase of an imaging frame coincides with the blinking period of an external light source at a predetermined frame interval is to be set as a frame period for flicker detection, a frame period where the phase of an imaging frame coincides with the blinking periods of a plurality of different external light sources at different frame intervals is set as a frame period for flicker detection. Then, by judging at which frame interval the brightness of a plurality of frame images sequentially captured with the frame period is being changed, it is judged which light is a flicker occurrence factor.

### CROSS-REFERENCE TO RELATED APPLICATION

This application is based upon and claims the benefit of priority from the prior Japanese Patent Application No 2015-186479, filed Sep. 24, 2015, the entire contents of which are incorporated herein by reference.

### BACKGROUND OF THE INVENTION

1. Field of the Invention

The present invention relates to an imaging apparatus which detects the occurrence factor of flicker in image capturing, based on the brightness of captured frame images.

2. Description of the Related Art

When an imaging apparatus such as a digital video camera captures images under an environment with a light source (for example, fluorescent tube) whose brightness periodically changes in accordance with a commercial power supply frequency (for example, 50 Hz or 60 Hz), flicker may occur in image signals because the brightness of the light source changes with a period of 1/100 seconds in a situation where the commercial power supply frequency is 50 Hz or changes with a period of 1/120 seconds in a situation where the commercial power supply frequency is 60 Hz. That is, due to brightness changes in accordance with the blinking period of an external light source, flicker may appear as the flickering of a monitor screen or moving images, or uneven streaky flicker may appear in a frame image.

In general, in order to detect such flicker, imaging parameters for easily detecting flicker are set, sequential image capturing is performed with these set imaging parameters, and a plurality of pieces of image data acquired by the image capturing are analyzed to judge whether flicker is present. Also, a technique in consideration of two types of commercial power supply frequencies (refer to Japanese Patent Application Laid-Open (Kokai) Publication No. 2002-084466) is known which detects whether the blinking period of an external light source (flicker frequency) is 100 Hz (twice as a commercial power supply frequency of 50 Hz) or 120 Hz (twice as a commercial power supply frequency of 60 Hz).

### SUMMARY OF THE INVENTION

In accordance with one aspect of the present invention, there is provided an imaging apparatus having a flicker detection function, comprising: an imaging section including an image sensor; and a control section including a processor, wherein the control section (i) sets, as a frame period for flicker detection, one frame period where a phase of an imaging frame coincides with a blinking period of an external light source at a predetermined frame interval, and (ii) judges that the external light source with the blinking period is a flicker occurrence factor, when brightness of a plurality of frame images sequentially captured with the set frame period is being changed at the predetermined frame interval, wherein the setting sets, as the frame period for flicker detection, one frame period where the phase of the imaging frame coincides with blinking periods of a plurality of different external light sources at different frame intervals, and wherein the judging judges which external light source with a blinking period is the flicker occurrence factor by judging at which frame interval corresponding to one of the blinking periods the brightness of the plurality of frame images sequentially captured with the one frame period is being changed.

The above and further objects and novel features of the present invention will more fully appear from the following detailed description when the same is read in conjunction with the accompanying drawings. It is to be expressly understood, however, that the drawings are for the purpose of illustration only and are not intended as a definition of the limits of the invention.

### BRIEF DESCRIPTION OF THE DRAWINGS

FIG. 1 is a block diagram showing basic components of a digital camera where the present invention has been applied as an imaging apparatus;

FIG. 2 is a schematic diagram showing brightness changes by flicker in the case of a commercial power supply frequency of 50 Hz (flicker frequency of 100 Hz) and the case of a commercial power supply frequency of 60 Hz (flicker frequency of 120 Hz);

FIG. 3 is a flowchart for describing an operation (characteristic operation of an embodiment) of the imaging apparatus (digital camera) which is started in response to power ON;

FIG. 4 is a flowchart for describing details of flicker detection processing (Step A6 of FIG. 3); and

FIG. 5 is a flowchart for describing details of imaging condition setting processing (Step A7 of FIG. 3).

### DETAILED DESCRIPTION OF THE PREFERRED EMBODIMENT

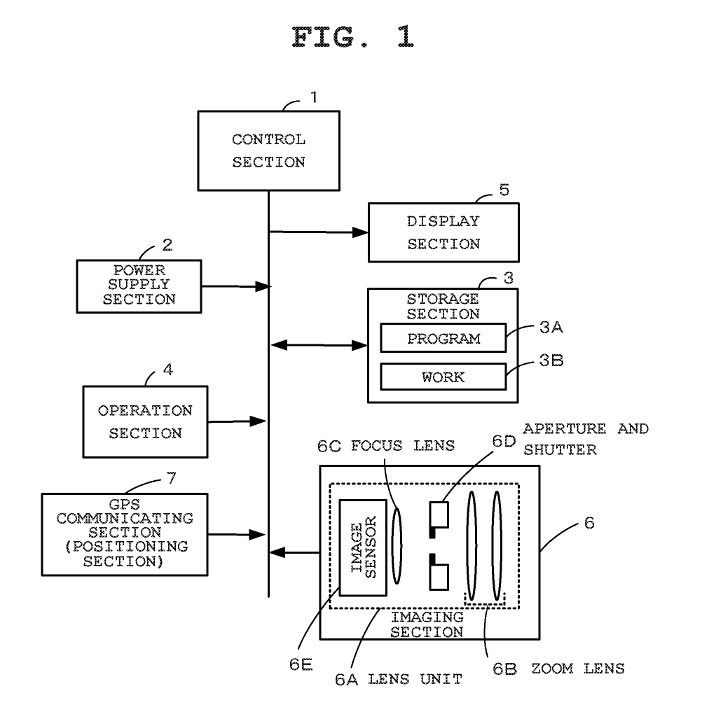

An embodiment of the present invention will hereinafter be described in detail with reference to FIG. 1 to FIG. 5.

FIG. 1 is a block diagram of basic components of a digital camera applied as an imaging apparatus.

This imaging apparatus (digital camera) is a digital video camera having a flicker detection function of detecting flicker appearing in frame images sequentially captured under an environment with a light source (for example, a fluorescent tube) whose brightness periodically changes in accordance with a commercial power supply frequency, based on brightness changes of the respective frame images, in addition to an imaging function, a replay function, a clock function, and the like. A control section 1 in FIG. 1 operates by power supply from a power supply section (secondary battery) 2, and controls the entire operation of the digital camera by following various programs in a storage section 3. This control section 1 is provided with a CPU (Central Processing Unit), a memory, and the like not shown.

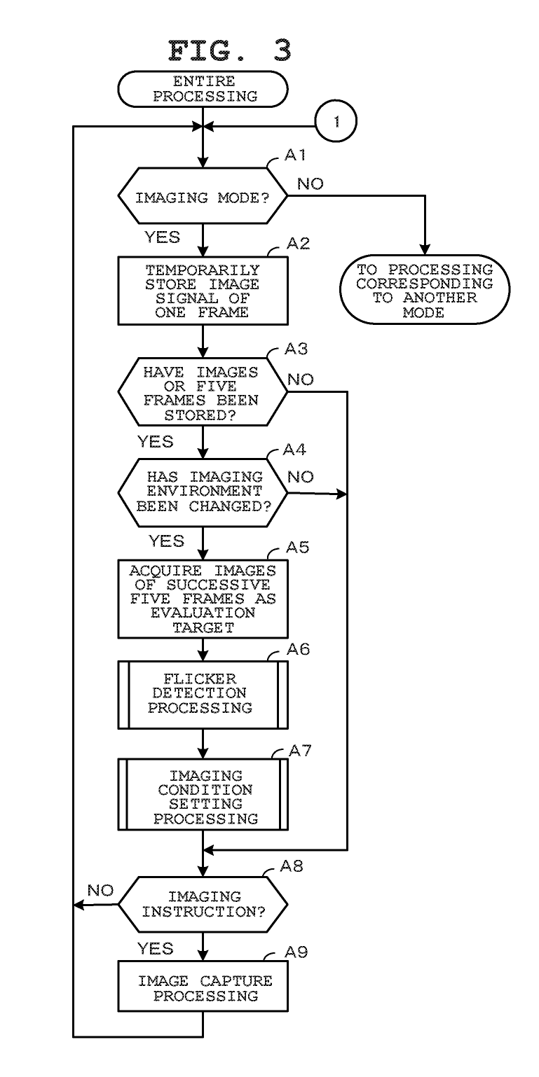

The storage section 3 is structured to have, for example, a ROM (Read Only Memory), a flash memory, and the like, and has a program memory 3A having stored therein a program and various applications for achieving the present embodiment in accordance with an operation procedure depicted in FIG. 3 to FIG. 5 described below, a work memory 3B that temporarily stores various information (for example, a flag) required for the camera to operate, and the like. Note that the storage section 3 may be structured to include a removable portable memory (recording medium) such as an SD (Secure Digital) card or an IC (Integrated Circuit) card, or may be structured to include, although not shown, a storage area on a predetermined server apparatus side in a case where the camera is connected to a network by a communication function.

An operation section 4 in FIG. 1 includes, although not depicted, a mode change button for switching between an operation mode capable of image capturing (imaging mode) and an operation mode for replaying a captured image (stored image) (replay mode), and a release button for providing an instruction to start image capturing, as well as various keys for setting imaging conditions such as exposure, shutter speed, aperture, and ISO film speed. As processing in response to an input operation signal from the operation section 4, the control section 1 performs, for example, mode change processing, image capture processing, imaging condition setting processing, and the like. A display section 5 in FIG. 1 is a high-definition liquid-crystal display, organic EL (Electro Luminescence) display, or the like, and serves as a monitor screen (live view screen) for displaying data of captured images (live view image) in real time or a replay screen for replaying captured image data.

An imaging section 6 in FIG. 1 constitutes a camera section capable of capturing a photographic subject with high definition, and has a lens unit 6A. The lens unit 6A is provided with a zoom lens 6B, a focus lens (in-focus lens) 6C, an aperture and shutter 6D, and an image sensor 6E. The image sensor 6E is, for example, a CCD (Charge-Coupled Device) image sensor for sequentially capturing images with a preset frame period for image capturing or a frame period for flicker detection described below, and has a plurality of charge-storage sections and a charge transfer section. The charge transfer section transfers all pixels at simultaneous timing in accordance with a global shutter technique (simultaneous exposure global reading technique). The image sensor 6E is not limited to a CCD image sensor, but may be a CMOS (Complementary Metal Oxide Semiconductor) image sensor using a rolling shutter technique (line exposure sequential reading technique).

An image signal (analog-value signal) read out from the image sensor 6E is converted into a digital signal (image signal) by an A/D converting section omitted in the drawings, subjected to predetermined image display processing, and then displayed on the display section 5 for monitor display in real time as a live view image. The control section 1 performs, in response to an operation on the release button (omitted in the drawings), predetermined image processing (such as development processing) on a captured image to generate a photographic image, performs image compression processing for conversion into a standard file format, and stores and records it in the recording medium of the storage section 3. A GPS communicating section (positioning section) 7 in FIG. 1 measures a current position (camera position) by using a ground/satellite-system control station. When the camera position is significantly changed (more than a predetermined value), the control section 1 judges that the imaging environment has been changed.

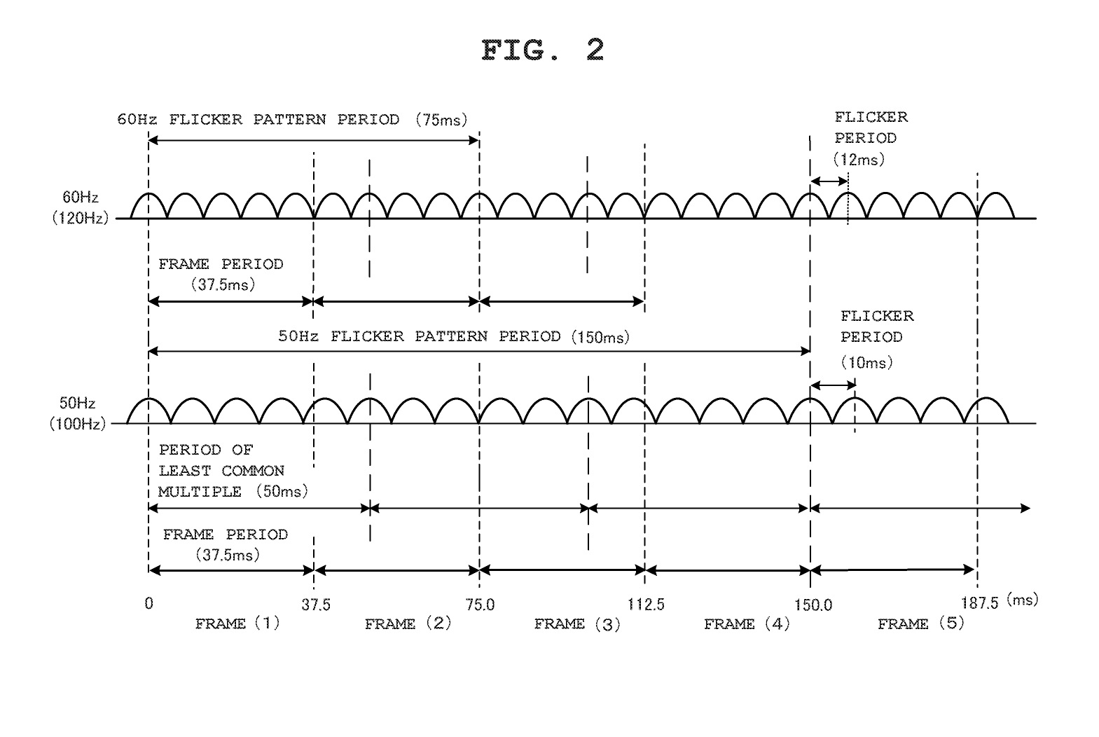

FIG. 2 is a schematic diagram showing brightness changes by flicker in the case of a commercial power supply frequency of 50 Hz (blinking period of an external light source: flicker frequency of 100 Hz) and the case of a commercial power supply frequency of 60 Hz (blinking period of an external light source flicker frequency of 120 Hz). Note that the commercial power supply frequency of 50 Hz is hereinafter simply referred to as 50 Hz and the commercial power supply frequency of 60 Hz is hereinafter simply referred to as 60 Hz.

In the drawing, the horizontal axis represents time (ms) and the vertical axis represents changes in brightness (changes in blinking). The solid waveforms schematically represent a waveform of brightness changes for 50 Hz and a waveform of brightness changes for 60 Hz.

Basically, a period (flicker occurrence period) in which an influence of flicker appears in a captured frame in moving image capturing (or live view capturing) is a period of the least common multiple of a blinking period of light that serves as a flicker factor (flicker factor period) and an imaging frame period. If the imaging frame period is an integral multiple of the flicker factor period, the flicker occurrence period coincides with the imaging frame period, and therefore no flicker influence occurs.

Also, if the imaging frame period is set such that the least common multiple of the flicker factor period and the imaging frame period is very large, the time required for flicker detection is too long. If this least common multiple is small, flicker detection can be made within a short period of time However, if flicker factors of 1/100 s and 1/120 s are both desired to be detected and processing of setting an imaging frame period for detecting each flicker factor and image capture processing with such settings are separately performed, the detection time is disadvantageously prolonged. Therefore, in order to more effectively (reliably and quickly) detect both flicker factors of 1/100 s and 1/120 s, processing of setting an imaging frame period for flicker detection and image capture processing with such settings are desired to be simultaneously and commonly performed.

However, as described above, even when an imaging frame period with a least common multiple smaller than either one of flicker factor periods of 1/100 s and 1/120 s is set, if the set imaging frame period has a least common multiple larger than the other flicker factor period or an integral multiple of the other flicker factor period, the flicker factor may not be detectable. Even if detectable, a long time will be required.

Hereafter, how to set an imaging frame period for more effective flicker detection is described.

Here, for example, when 1/20 s, that is, the least common multiple of 50 Hz (flicker factor period of 1/100 s) and 60 Hz (flicker factor period of 1/120 s) is set at the image imaging frame period (50 ms), the image imaging frame period is an integral multiple of both flicker factor periods. Therefore, as depicted in the drawing, the waveform of changes in brightness at 50 Hz and the waveform of changes in brightness at 60 Hz are in phase with each other (all frames are in phase)

Here, a case is described in which an imaging frame period slightly shifted from the least common multiple of 1/20 s of both flicker factor periods is set so as not to be an integral multiple of any flicker factor period and to have a sufficiently small least common multiple of any flicker factor periods.

In 50±α (slightly shifted value), α is set at 12.5, and this formula is further transformed into 12.5+25.0×N.

As a value excluding integral multiples of the flicker factor periods of 1/100 s (10 ms) and 1/120 s (12 ms), for example, 37.5 ms (when the above-mentioned N is 1) is set as a frame period of the image sensor 6E. Then, as depicted in the drawing, a flicker pattern (brightness change pattern) of 50 Hz is a pattern period repeated for every four frames (150 ms), and a flicker pattern of 60 Hz is a pattern period repeated for every two frames (75 ms).

As a result, the pattern is the same as a pattern for previous two frames for 60 Hz, and the pattern is the same as a pattern for previous four frames for 50 Hz and 60 Hz. With four frames and two frames, the imaging frame period of 37.5 ms is not a multiple of both flicker factor periods, and the least common multiple is the smallest for both of the flicker factor periods, whereby most efficient detection can be made. That is, if at least 4+α successive frame images can be acquired, two types of flicker can be simultaneously detected. As a result, flicker detection time is shortened, and the capacity of the temporary storage memory for flicker detection can also be reduced. Here, other than 37. 5 ms, an imaging frame period satisfying the above-described conditions exists. However, 37.5 ms is optimum for two flicker factor periods of 1/100 s and 1/120 s.

Hereafter, a flicker detecting method when an imaging frame period is set at 37.5 ms is more specifically described.

As described above, a frame interval where an imaging frame and each of a plurality of different flicker factor periods (a period for 50 Hz is referred to as a first blinking period and a period for 60 Hz is referred to as a second blinking period) are in phase varies. The frame interval for 50 Hz is a four-frame interval, and the frame interval for 60 Hz is a two-frame interval. In this case, in the present embodiment, a frame period where the phase of an imaging frame coincides with a plurality of different flicker factor periods (first and second blinking periods) at different frame intervals, such as 37.5 ms, is temporarily set as a frame period for flicker detection.

That is, a frame period for flicker detection is set (for example, 37.5 ms) such that a frame interval (four-frame interval) where the phase of an imaging frame coincides with the flicker factor period of 1/100 s (10 ms), that is, the first blinking period is taken as a first frame interval, and a frame interval (two-frame interval) where the phase of the imaging frame coincides with the flicker factor period of 1/120 s (12 ms), that is, the second blinking period is taken as a second frame interval.

In the drawing, an initial period from 0 ms to 37.5 ms represents a first frame (1), a period from 7.5 ms to 75.0 ms represents a second frame (2), a period from 75.0 ms to 112.5 ms represents a third frame (3), a period from 112.5 ms to 150 ms represents a fourth frame (4), and a period from 150.0 ms to 187.5 ms represents a fifth frame (5). In this state where the frame period for flicker detection (for example, 37.5 ms) has been set, the control section 1 compares a plurality of frame images (for example, images for five frames) in brightness, judges whether the brightness of the plurality of frame images has been changed with a frame interval (the four-frame interval as the first frame interval and the two-frame interval as the second frame interval) corresponding to one of the plurality of blinking periods (first and second blinking periods), and thereby judges which light in a blinking period is a flicker occurrence factor.

That is, when the plurality of frame images are compared in brightness and a brightness difference between two frame images separated at the second frame interval (two-frame interval) is equal to or larger than a predetermined value and a brightness difference between two frame images separated at an interval different from the second frame interval (for example, successive two frame images) is equal to or larger than a predetermined value, the control section 1 judges that light in the first blinking period (flicker factor period for 50 Hz) is a flicker occurrence factor. Note that two frame images separated at the second frame interval (two-frame interval) are compared because the phase is inverted and the brightness difference is large (the same applies hereafter). On the other hand, when the brightness difference between two frame images separated at the second frame interval (two-frame interval) is smaller than the predetermined value and the brightness difference between two frame images separated at the interval different from the second frame interval (for example, successive two frame images) is equal to or larger than the predetermined value, the control section 1 judges that light in the second blinking period (flicker factor period for 60 Hz) is a flicker occurrence factor.

In this case, on condition that the brightness difference between two frame images separated at a frame interval of the least common multiple (four-frame interval) of the first frame interval (four-frame interval) and the second frame interval (two frame interval) is equal to or smaller than a predetermined value, the control section 1 judges a blinking period as a flicker occurrence factor, and the reason for this will be described further below. Also, when the brightness difference between successive two frame images is smaller than the predetermined value, the control section 1 judges that neither light with the first blinking period nor light the second blinking period is a flicker occurrence factor (no flicker). After this flicker detection processing is performed, the control section 1 changes the setting of the frame period for flicker detection (for example, 37.5 ms) to setting of a frame period for normal imaging, and changes imaging conditions such as an exposure time in accordance with the detected flicker occurrence factor.

Next, the operation concept of the imaging apparatus (digital camera) in the present embodiment is described with reference to the flowcharts depicted in FIG. 3 to FIG. 5. Here, each function described in the flowcharts is stored in a readable program code format, and operations based, on these program codes are sequentially performed. Also, operations based on the above-described program codes transmitted over a transmission medium such as a network can also be sequentially performed. That is, the unique operations of the present embodiment can be performed using programs and data supplied from an outside source over a transmission medium, in addition to a recording medium.

FIG. 3 is a flowchart for describing an operation (characteristic operation of the present embodiment) of the imaging apparatus (digital camera) which is started in response to power ON.

First, the control section 1 judges whether the current mode has been switched to an imaging mode in response to a power supply ON operation (Step A1). When the current mode has been switched to another mode such as a replay mode (NO at Step A1), the control section 1 proceeds to processing corresponding to another mode. When the current mode has been switched to the imaging mode (YES at Step A1), the control section 1 temporarily stores an image of one frame in the work memory 3B (Step A2). Then, the control section 1 judges whether images of five frames have been stored in the work memory 3B, that is, whether flicker detection timing has been reached (Step A3).

Note that the work memory 3B temporarily stores, as frame images previous to the latest frame image, at least frame images of the least common multiple of the first frame interval and the second frame interval (for example, images of four frames). In the present embodiment the work memory 3B temporarily stores images of five frames including the latest frame image. At this first stage, only the image of the first frame has been stored in the work memory 3B (NO at Step A3), the control section 1 proceeds to the next Step A8 to judge whether an imaging instruction operation has been performed. When judged that an imaging instruction has not been provided (NO at Step A8), the control section 1 returns to the initial Step A1.

Here, if images of five frames have been stored in the work memory 3B that is, if flicker detection timing has been reached (YES at Step A3), the control section 1 judges whether the imaging environment has been changed since the time of flicker detection (Step A4). Note that “change in imaging environment” herein occurs, for example, when power supply is turned ON, when a predetermined time elapses from previous flicker detection, when a photographing position (camera position) acquired from the GPS communicating section 7 is changed, when the status of a photographic subject detected by image analysis during moving image capturing is changed, when the release button is pressed halfway down, or when switching is made to the imaging mode. Here, if the imaging environment has not been changed since the previous flicker detection (NO at Step A4), the control section 1 proceeds to the next Step A6 to judge whether an imaging instruction operation has been performed.

In the present embodiment, although images of latest five frames are always temporarily stored irrespective of a judgment result as to whether the imaging environment has been changed, images of five frames may be temporarily stored only when the imaging environment has been changed.

When judged that an imaging instruction has not been provided (NO at Step A8), the control section 1 returns to the initial Step A1 to perform the above-described operation (Steps A1 to A4). Then, when the imaging environment is detected to have been changed (YES at Step A4), the control section 1 acquires images of successive five frames from the work memory 3B as an evaluation target for flicker detection (Step A5). Subsequently, after performing flicker detection processing described below (Step A6), the control section 1 proceeds to imaging condition setting processing (Step A7) described below. Then, the control section 1 judges whether an imaging instruction operation has been performed (Step A8). When an imaging instruction has been provided (YES at Step A8), the control section 1 performs the series of image capture processing (Step A9) for recording and storing captured images, and then returns to the initial Step A1. Conversely, when an imaging instruction has not been provided (NO at Step A8), the control section 1 directly returns to the initial Step A1.

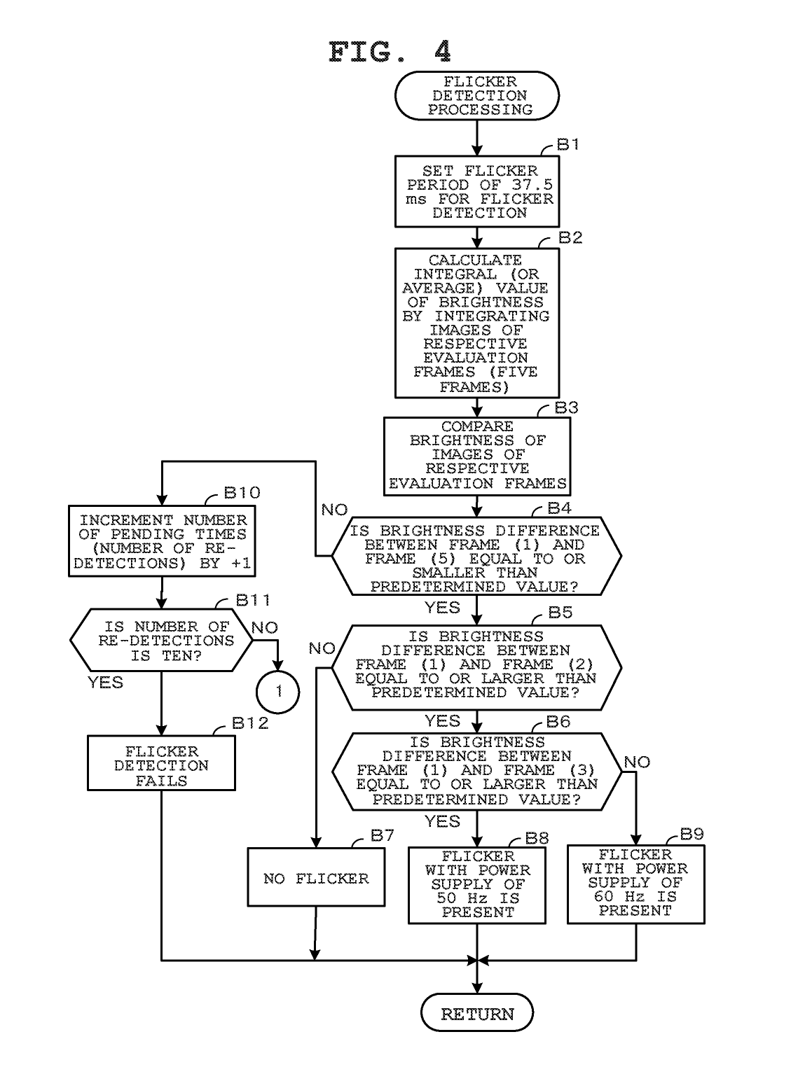

FIG. 4 is a flowchart for describing details of flicker detection processing (Step A6 of FIG. 3).

First, the control section 1 finds a value (37.5 ms) when N is set at “1” by using the above-described calculation equation “frame period=12.5+25.0×N(ms)”, and sets this value as a frame period for flicker detection (Step B1). The frame period for flicker detection is not limited to 37.5 ms described above, and may be a value acquired by, for example, setting the above-described N value at “2”, “3”, or the like.

Next, the control section 1 performs integral calculation of image signals of the respective evaluation frames (successive five frames) acquired from the work memory 3B to calculate an integral (or average) value of brightness (Step B2), and compares the respective frame images in brightness (Step B3). For example, the control section 1 compares the brightness of frame (5) that is the latest frame and the brightness of frame (1) that is previous thereto at the first frame interval (by four frames), compares the brightness of frame (1) and frame (2) that are successive in time, or compares the brightness of frame (1) and frame (3) that are separated at the second frame interval (by two frames).

Then, as a result of the comparison in brightness between the respective evaluation frames described above, the control section 1 judges whether a brightness difference therebetween is smaller than a predetermined value or larger than a predetermined value (Steps B4 to B6). First, the control section 1 compares two frame images separated at the frame interval (four-frame interval) of the least common multiple of the first frame interval (four-frame interval) and the second frame interval (two-frame interval). For example, the control section 1 compares the image of latest frame (5) and the image of frame (1) that is previous thereto by four frames to judge whether a brightness difference therebetween is equal to or smaller than a predetermined value (Step B4). This predetermined value is a threshold set in advance to judge, based on a change in image brightness, whether the possibility that the imaging apparatus and the subject have not moved is high.

Here, if the brightness has been hardly changed and the brightness difference is equal to or smaller than the predetermined value (YES at Step B4), the possibility that the imaging apparatus and the subject have not moved is high, and therefore the control section 1 judges that timing suitable for frame evaluation (flicker detection) has been reached. If the brightness has been significantly changed to the extent that the difference exceeds the predetermined value (NO at Step B4), the possibility that the imaging apparatus and the subject have moved is high, and therefore the control section 1 proceeds to Step B10 to increment the number of pending times (number of re-detections) by “1” to set flicker detection to be temporarily pending. Then, the control section 1 judges whether the number of pending times (number of re-detections) has reached ten (Step B11). Initially, the number has not reached ten (NO at Step B11), and therefore the control section 1 returns to Step A1 of FIG. 3.

As a result, when images of five frames are temporarily stored in the work memory 3B as a new evaluation target (YES at Step A3), that is, when flicker detection timing is reached, the control section 1 again acquires new evaluation frames (five frames that are successive in time) (Step A5) on condition that the imaging environment has been changed (YES at Step A4), and then proceeds to flicker detection processing (Step A6). Hereafter, if the brightness difference between frame (5) and frame (1) are exceeding the predetermined value even after Steps B1 to B4 are performed (NO at Step B4), the control section 1 repeats processing of updating the value of the number of re-detections (Step B10). Then, when the number of re-detection reaches ten (YES at Step B11), the control section 1 judges that the current situation is not suitable for frame evaluation (flicker detection) (“flicker detection fails”) (Step B12), and exits from the flow of FIG. 4.

On the other hand, as a result of comparing the images of frame (5) and frame (1), if the brightness difference therebetween is equal to or smaller than the predetermined value (YES at Step B4), the control section 1 judges that the current situation is suitable for frame evaluation (flicker detection), and proceeds to Step B5 to judge whether the brightness difference between successive two frame images, such as the images of frame (1) and frame (2), is equal to or larger than a predetermined value (Step B5). Here, the predetermined value is a threshold set in advance to judge the presence or absence of flicker based on change in image brightness. Here, when the brightness difference between successive two frame images is equal to or larger than the predetermined value, flicker appears for either one of 50 Hz and 60 Hz. When the brightness difference is smaller than the predetermined value (NO at Step B5), the control section 1 judges that no flicker has appeared for 50 Hz and 60 Hz (Step B7).

Also, when the brightness difference between successive two frame images is equal to or larger than the predetermined value (YES at Step B5), the control section 1 compares images of two frames separated at the second frame interval (two-frame interval). For example, the control section 1 compares the images of frame (1) and frame (3) to judge whether a brightness difference therebetween is equal to or larger than a predetermined value (Step B6). Here, the predetermined value is a threshold set in advance to judge whether flicker has appeared for 50 Hz or for 60 Hz. Here, when the brightness difference between frame (1) and frame (3) is equal to or larger than the predetermined value (YES at Step B6), the control section 1 judges that flicker has appeared for 50 Hz (judges that flicker with power supply of 50 Hz is present) (Step B8). When the brightness difference between frame (1) and frame (3) is smaller than the predetermined value (NO at Step B6), the control section 1 judges that flicker has appeared for 60 Hz (judges that flicker with power supply of 60 Hz is present) (Step B9). Then, after making this judgment the control section 1 exits from the flow of FIG. 4.

As described above, in the flicker detection processing, when a brightness difference between two frame images separated at the second frame interval (two-frame interval) is equal to or larger than the predetermined value (YES at Step B6) and a brightness difference between two frame images separated at an interval different from the second frame interval (for example, successive two frame images) is equal to or larger than the predetermined value (YES at Step B5), the control section 1 judges that light with the first blinking period (flicker factor period for 50 Hz) is a flicker occurrence factor (Step B8). Also, when a brightness difference between two frame images separated at the second frame interval (two-frame interval) is smaller than the predetermined value (NO at Step B6) and a brightness difference between two frame images separated at an interval different from the second frame interval (for example, successive two frame images) is equal to or larger than the predetermined value (YES at Step B5), the control section 1 judges that light with the second blinking period (flicker factor period for 60 Hz) is a flicker occurrence factor (Step B9).

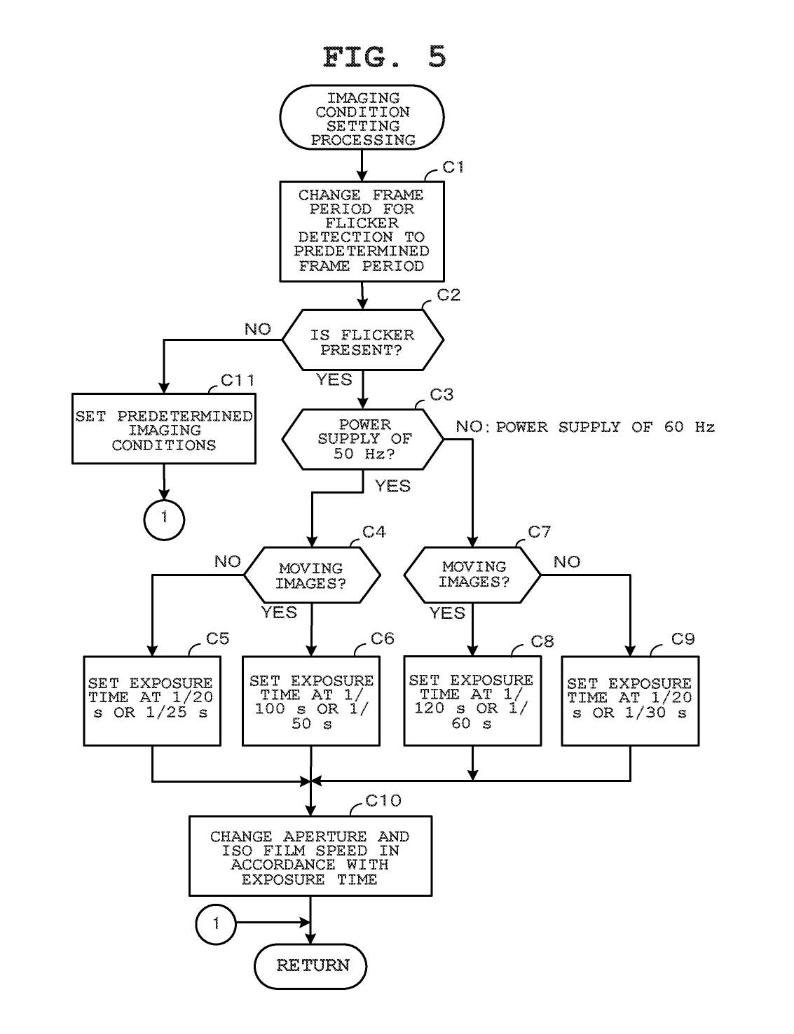

FIG. 5 is a flowchart for describing details of imaging condition setting processing (Step A7 of FIG. 3).

First, as an imaging condition, the control section 1 performs processing of returning the frame period set for flicker detection (for example, 37.5 ms) to a predetermined imaging frame period (frame rate) set in advance (Step C1). Then, with reference to the flicker detection result, the control section 1 judges whether a judgment “flicker is present” has been made (Step C2). When a judgment “no flicker” has been made (NO at Step C2), the control section 1 performs processing of setting predetermined imaging conditions such as an exposure time as other imaging conditions (Step C11), and then exits from the flow of FIG. 5.

When a judgment “flicker is present” has been made (YES at Step C2), the control section 1 further judges whether a judgment “flicker with power supply of 50 Hz is present” has been made (Step C3) Here, when a judgment “flicker with power supply of 50 Hz is present” has been made (YES at Step C3) and still images are being captured (NO at Step C4), the control section 1 sets 1/20 s or 1/25 s as an exposure time (Step C5). When a moving image is being captured (YES at Step C4), the control section 1 sets 1/100 s or 1/50 s as an exposure time (Step C6).

On the other hand, when a judgment “flicker with power supply of 60 Hz is present” has been made (NO at Step C3) and a moving image is being captured (YES at Step C7), the control section 1 sets 1/120 s or 1/60 s as an exposure time (Step C8). When still images are captured (NO at Step C7), the control section 1 sets 1/20 s or 1/30 s as an exposure time (Step C9). For example, for moving image capturing, as an imaging condition for reducing the occurrence of flicker, the control section 1 sets an exposure time for 50 Hz (flicker factor period of 1/100 s), 60 Hz (flicker factor period of 1/120 s), or an integer multiple thereof (1/50 s or 1/60 s). When the exposure time is changed in accordance with a flicker detection result as described above, aperture and ISO film speed are changed to ensure brightness with that change (Step C10). Then, the control section 1 exits from the flow of FIG. 5.

As described above, in the present embodiment when a frame period where the phase of an imaging frame coincides with the blinking period of an external light source at a predetermined frame interval is to be set as a frame period for flicker detection, a frame period where the phase of an imaging frame coincides with the blinking periods of a plurality of different external light sources (for example, flicker factor periods for 50 Hz and 60 Hz) at different frame intervals is set as a frame period for flicker detection. Then, by judging at which frame interval corresponding to one of the plurality of blinking periods the brightness of a plurality of frame images sequentially captured with the frame period is changed, the control section 1 judges which light with a blinking period is a flicker occurrence factor. As a result of this configuration, it is possible to reliably and quickly detect which light source with a blinking period is a flicker occurrence factor among a plurality of different external light sources with blinking periods.

Also, in a state where a plurality of frame images sequentially captured with a frame period set as a frame period for flicker detection has been temporarily stored in the work memory 3B, images of a plurality of frames (for example, five frames) temporarily stored in the work memory 3B are compared in brightness. When a brightness difference between two frame images separated at the second frame interval is equal to or larger than the predetermined value and a brightness difference between two frame images separated at an interval different from the second frame interval is equal to or larger than the predetermined value, light with the first blinking period (flicker factor period for 50 Hz) is judged as a flicker occurrence factor. Therefore, it is possible to easily judge a flicker occurrence factor only by comparing a plurality of frame images in brightness.

Moreover, a plurality of frame images temporarily stored in the work memory 3B are compared in brightness and, when a brightness difference between two frame images separated at the second frame interval is smaller than the predetermined value and a brightness difference between two frame images separated at an interval different from the second frame interval is larger than the predetermined value, light with the first blinking period (flicker factor period for 60 Hz) is judged as a flicker occurrence factor. Therefore, it is possible to easily judge a flicker occurrence factor only by comparing a plurality of frame images in brightness.

Furthermore, since two frame images separated at the interval different from the second frame interval are successive two frame images, if the brightness difference between these two frame images is equal to or larger than the predetermined value, one of a plurality of different external light sources with blinking periods can be judged as a flicker occurrence factor.

Still further, a blinking period serving as a flicker occurrence factor is judged on condition that a brightness difference between two frame images separated at a frame interval (for example, four frames) of the least common multiple of the first frame interval and the second frame interval is equal to or smaller than the predetermined period. As a result of this configuration, if a brightness difference between two frame images exceeds the predetermined value. it is judged that the possibility that the imaging apparatus and the photographic subject have moved is high and therefore it is not suitable timing for frame evaluation (flicker detection).

Yet still further, when a brightness difference between successive two frame images is smaller than the predetermined value, neither light with the first blinking period nor light with the first blinking period is judged as a flicker occurrence factor (no flicker). Therefore, detection of no flicker can also be easily made.

Yet still further, in the work memory 3B, when frame images (for example, images of four frames) of the least common multiple of the first frame interval and the second frame interval are temporarily stored as frame images previous to the latest frame image, and a brightness difference between two frame images separated at a frame interval of the least common multiple is judged to exceed the predetermined value, control is performed such that a plurality of other frame images are temporarily stored in the work memory 3B. As a result of this configuration, flicker detection can be made based on a plurality of immediately previous frame images.

Yet still further, after the blinking period of an external light source serving as a flicker occurrence factor is judged, a frame period for image capturing is set in place of a frame period set for flicker detection. As a result of this configuration, after flicker detection, image capturing is performed with a frame period for image capturing.

Yet still further, an imaging condition for reducing the occurrence of flicker is set for image capturing based on a result of judgment regarding a flicker occurrence factor. As a result of this configuration, captured images without flicker can be acquired.

Yet still further, as an Imaging condition for reducing the occurrence of flicker, a change is made to set an exposure time of blinking periods of a plurality of different external light sources or an integer multiple thereof. As a result of this configuration, captured images without flicker can be acquired.

Yet still further, in order to ensure brightness in accordance with a change in exposure time, at least one of an aperture value and an ISO film speed is changed. As a result of this configuration, brightness in image capturing can be prevented from being impaired by change in exposure time.

Yet still further, when a first blinking period corresponding to a power supply frequency for 50 Hz and a second blinking period corresponding to a power supply frequency for 60 Hz are set as a plurality of blinking periods, 12.5+25.0×N (in units of ms and N is an integer) is set as a frame period. As a result of this configuration, a frame period for flicker detection can be found and set by simple calculation.

Yet still further, flicker detection is performed when a change in an imaging environment is detected. As a result of this configuration, flicker detection can be performed at appropriate timing, which makes it more reliable. For example, even when the apparatus has moved from an area of 50 Hz to an area of 60 Hz, flicker detection can be performed when a predetermined time elapses, power supply is ON, or the camera position is changed. Therefore, an external light source with a blinking period serving as a flicker occurrence factor can be reliably and quickly detected from among a plurality of different external light sources with blinking periods when an imaging environment is changed.

In the above-described embodiment, a flicker occurrence factor is considered as blinking of a fluorescent tube due to one of power supply frequencies of two types, 50 Hz and 60 Hz, and a frame period for flicker detection is found by a formula “12.5+25.0×N (in units of ms and N is an integer)”. However, the present invention is not limited thereto, and a frame period may be found by following the next equations if a factor which periodically changes brightness in image capturing is present.

That is, when two blinking periods of external light sources are S1 and S2; the least common multiple of S1 and S2 is S12; a frame period is F; k1 and k2 are different prime numbers; and m1, m2, m12, and N are any integers, “F” satisfying the following relations may be set as a frame period:

S1×k1=S12×m2/m12;

S2×k2=S12×m2/m12; and

F=S12×(N±1/m12).

For example, when this is applied to blinking periods due to power supply frequencies of two types such as 50 Hz and 60 Hz described in the above embodiment, if S1=1/100 s and S2=1/120 s, and k1=5, k2=3, m1=4, m2=2, and m12=4, a frame period “F” is found by F=1/20 s×(N±1/4 ).

In the above-described embodiment, since the frame period for flicker detection is set at 37.5 ms, the flicker pattern for 50 Hz (light/dark changing pattern) has a pattern period (150 ms) repeating every four frames, and the flicker pattern for 60 Hz has a pattern period (75 ms) repeating every two frames. Also, the first frame interval is a four-frame interval and the second frame interval is a two-frame interval. However, the first frame interval and the second frame interval are not limited thereto, and may be varied depending on the frame period for flicker detection.

That is, a frame period “F” with smaller m1 and m2 in the above formulas may be adopted.

Also, the image sensor 6E described above is not limited to a CCD image sensor, and may be a CMOS image sensor adopting a global shutter technique. In this case as well, after image signals for each or several lines are integrated to calculate an integral (or average) value of brightness, brightness comparison may be performed.

Moreover, in the above-described embodiment, the present invention has been applied to a digital camera as an imaging apparatus. However, the present invention is not limited thereto, and may be applied to a camera-function-equipped personal computer, PDA (personal digital assistance), a tablet terminal device, a portable telephone such as smartphone, an electronic game machine, a music player, and the like.

Furthermore, the “apparatuses” or the “sections” described in the above-described embodiment are not required to be in a single housing and may be separated into a plurality of housings by function. In addition, the steps in the above-described flowcharts are not required to be processed in time-series, and may be processed in parallel, or individually and independently.

While the present invention has been described with reference to the preferred embodiment, it is intended that the invention be not limited by any of the details of the description therein but includes all the embodiments which fall within the scope of the appended claims.

What is claimed is:

1. An imaging apparatus having a flicker detection function, comprising:
an imaging section including an image sensor; and
a control section including a processor,
wherein the control section (i) sets, as a frame period for flicker detection, one frame period where a phase of an imaging frame coincides with a blinking period of an external light source at a predetermined frame interval, and (ii) judges that the external light source with the blinking period is a flicker occurrence factor, when brightness of a plurality of frame images sequentially captured with the set frame period is being changed at the predetermined frame interval,
wherein the setting sets, as the frame period for flicker detection, one frame period where the phase of the imaging frame coincides with blinking periods of a plurality of different external light sources at different frame intervals, and
wherein the judging judges which external light source with a blinking period is the flicker occurrence factor by judging at which frame interval corresponding to one of the blinking periods the brightness of the plurality of frame images sequentially captured with the one frame period is being changed.

2. The imaging apparatus according to claim 1, wherein the plurality of frame images sequentially captured with the set frame period is temporarily stored in a memory,
wherein the setting sets the blinking periods of the plurality of different external light sources as a first blinking period and a second blinking period, and sets the frame period for flicker detection such that a frame interval at which the phase of the imaging frame coincides with the first blinking period is a first frame interval and a frame interval at which the phase of the imaging frame coincides with the second blinking period is a second frame, and
wherein the judging compares the brightness of the plurality of frame images temporarily stored in the memory, and judges an external light sources with the first blinking period as the flicker occurrence factor, when a brightness difference between two frame images separated at the second frame interval is equal to or larger than a predetermined value and a brightness difference between two frame images separated at an interval different from the second frame interval is equal to or larger than a predetermined value.

3. The imaging apparatus according to claim 2, wherein the judging compares the brightness of the plurality of frame images temporarily stored in the memory, and judges an external light sources with the second blinking period as the flicker occurrence factor, when the brightness difference between the two frame images separated at the second frame interval is smaller than the predetermined value and the brightness difference between the two frame images separated at the interval different from the second frame interval is equal to or larger than the predetermined value.

4. The imaging apparatus according to claim 2, wherein the two frame images separated at the interval different from the second frame interval are successive two frames.

5. The imaging apparatus according to claim 2, wherein the judging makes a judgment regarding a blinking period serving as the flicker occurrence factor, on condition that a brightness difference between two frame images separated at a frame interval of a least common multiple of the first frame interval and the second frame interval is equal to or smaller than a predetermined value.

6. The imaging apparatus according to claim 4, wherein the judging judges that neither of the external light sources with the first blinking period and an external light sources with the second blinking period is the flicker occurrence factor, when a brightness difference between the successive two frame images is equal to or smaller than a predetermined value.

7. The imaging apparatus according to claim 2, wherein the temporal storage temporarily stores at least frame images of a least common multiple of the first frame interval and the second frame interval as frame images previous to a latest frame image, and
wherein control is performed such that a plurality of other frame images are temporarily stored in the memory when a brightness difference between two frame images separated at a frame interval of the least common multiple is judged to exceed a predetermined value in the judging.

8. The imaging apparatus according to claim 1, wherein the setting sets a frame period for image capturing in place of the set frame period for flicker detection, after the blinking period of the external light source serving as the flicker occurrence factor is judged in the judging.

9. The imaging apparatus according to claim 8, wherein the imaging section is controlled such that image capturing is performed with an imaging condition for reducing occurrence of flicker being set based on a judgment result in the judging.

10. The imaging apparatus according to claim 9, wherein the controlling for the image capturing changes an exposure time to an exposure time of the blinking periods of the plurality of different external light sources or an integer multiple thereof, as the imaging condition for reducing the occurrence of flicker.

11. The imaging apparatus according to claim 10, wherein the controlling for the image capturing changes at least one of an aperture value and an ISO film speed so as to ensure brightness in accordance with the change of the exposure time.

12. The imaging apparatus according to claim 1, wherein the setting sets, as the frame period, 12.5+25.0×N in units of ms where N is an integer, when the blinking periods include a first blinking period corresponding to a power supply frequency of 50 Hz and a second blinking period corresponding to a power supply frequency of 60 Hz.

13. The imaging apparatus according to claim 1, wherein a change in an imaging environment is detected,
wherein the setting sets the frame period for flicker detection when a change in the imaging environment is detected, and
wherein the judging judges the flicker occurrence factor when a change in the imaging environment is detected.

14. A flicker detection method for an imaging apparatus comprising:
a step of, in a case where one frame period where a phase of an imaging frame coincides with a blinking period of an external light source at a predetermined frame interval is set as a frame period for flicker detection, setting one frame period where the phase of the imaging frame coincides with blinking periods of a plurality of different external light sources at different frame intervals as the frame period for flicker detection, and
a step of, in a case where an external light source with a blinking period is judged as a flicker occurrence factor when brightness of a plurality of frame images sequentially captured with the set frame period is being changed at the predetermined frame interval, judging which external light source with a blinking period is the flicker occurrence factor by judging at which frame interval corresponding to one of the blinking periods the brightness of the plurality of frame images is being changed.

15. A non-transitory computer-readable storage medium having stored thereon a program that is executable by a computer in an imaging apparatus to actualize functions comprising:
processing for, in a case where one frame period where a phase of an imaging frame coincides with a blinking period of an external light source at a predetermined frame interval is set as a frame period for flicker detection, setting one frame period where the phase of the imaging frame coincides with blinking periods of a plurality of different external light sources at different frame intervals, as the frame period for flicker detection, and
processing for, in a case where an external light source with a blinking period is judged as a flicker occurrence factor when brightness of a plurality of frame images sequentially captured with the set frame period is being changed at the predetermined frame interval, judging which external light source with a blinking period is the flicker occurrence factor by judging at which frame interval corresponding to one of the blinking periods the brightness of the plurality of frame images is being changed.
